(19) United States
(12) Patent Application Publication
(10) Pub. No.: US 2026/0184158 A1
(43) Pub. Date: Jul. 2, 2026

(54) BOTTOM STRUCTURE OF VEHICLE

(71) Applicant: Honda Motor Co., Ltd., Tokyo (JP)

(72) Inventor: Hiroto SUGIYAMA, Saitama (JP)

(73) Assignee: Honda Motor Co., Ltd., Tokyo (JP)

(21) Appl. No.: 19/419,159

(22) Filed: Dec. 15, 2025

(30) Foreign Application Priority Data
Dec. 27, 2024 (CN) 202411952060.3

(51) Int. Cl. B60K 1/04; B60S 11/00; B62D 21/02

(52) U.S. Cl. CPC B60K 1/04; B60S 11/00; B62D 21/02; B60K 2001/0438

(57) ABSTRACT

Provided is a bottom structure of a vehicle, which can provide good waterproof effect and good operability of a lifting operation. The bottom structure of the vehicle includes: a vehicle body having a base plate; a battery disposed under the base plate; a battery fixing portion disposed at a position closer to an outer side of the vehicle compared to the battery and fixes the battery to the vehicle body; a lifting component disposed at a position closer to the outer side of the vehicle compared to the battery fixing portion; a lower end of the lifting component having a jack receiving portion; and a cover component disposed under the battery and covers a lower portion of the battery fixing portion. The cover component has an internal contact portion, which is located above the jack receiving portion, and contacts the lifting component from an inner side of the lifting component.

### CROSS-REFERENCE TO RELATED APPLICATION

This application claims the priority benefit of China application serial no. 202411952060.3, filed on December 27, 2024. The entirety of the above-mentioned patent application is hereby incorporated by reference herein and made a part of this specification.

### BACKGROUND

### Technical Field

The disclosure relates to a local structure of a vehicle, and particularly relates to a bottom structure of a vehicle.

### Related Art

Electric vehicles are typically equipped with large batteries located under the base plate of the vehicle body. In order to prevent the bolts configured to fix the battery from getting wet and rusting, some vehicles have covers installed at the bottom portion to prevent water splashing. However, the covers obstruct the lifting components of the vehicle, so the covers need to be unloaded each time a jack is used, which causes operational inconvenience. Therefore, it is needed to improve the bottom structure of the vehicle to overcome the foregoing problem.

### SUMMARY

The disclosure provides a bottom structure of a vehicle, which can provide good waterproof effect and good operability of a lifting operation.

The disclosure provides the bottom structure of the vehicle, which includes: a vehicle body having a base plate; a battery disposed under the base plate; a battery fixing portion disposed at a position closer to an outer side of the vehicle compared to the battery, and fixing the battery to the vehicle body; a lifting component disposed at a position closer to the outer side of the vehicle compared to the battery fixing portion; a lower end of the lifting component having a jack receiving portion; and a cover component disposed under the battery and covering a lower portion of the battery fixing portion. The cover component has an internal contact portion. The internal contact portion is located above the jack receiving portion, and contacts the lifting component from an inner side of the lifting component in a width direction of the vehicle.

In an embodiment of the disclosure, the cover component has an external contact portion. The external contact portion contacts the lifting component from an outer side of the lifting component in the width direction of the vehicle.

In an embodiment of the disclosure, the cover component includes an inner cover component and an outer cover component that are separately formed. The inner cover component has the internal contact portion. The outer cover component has the external contact portion.

In an embodiment of the disclosure, the inner cover component and the outer cover component overlap and are connected to each other at a front side of the internal contact portion and a rear side of the internal contact portion.

In an embodiment of the disclosure, the lifting component has a longitudinal wall portion extending along a top-bottom direction of the vehicle. The jack receiving portion extends from a lower end of the longitudinal wall portion along the width direction of the vehicle toward an inner side of the vehicle. The inner cover component includes a first inner cover component and a second inner cover component that are separately formed. The first inner cover component has the internal contact portion. The second inner cover component covers a lower portion of the battery and is connected to the first inner cover component.

In an embodiment of the disclosure, the first inner cover component and the outer cover component overlap and are connected to each other at a front side of the internal contact portion and a rear side of the internal contact portion.

In an embodiment of the disclosure, the lifting component has a longitudinal wall portion extending along a top-bottom direction of the vehicle. The jack receiving portion extends from a lower end of the longitudinal wall portion along the width direction of the vehicle toward an inner side of the vehicle. The cover component includes a first inner cover component and a second inner cover component that are separately formed. The first inner cover component has the internal contact portion. The second inner cover component covers a lower portion of the battery and is connected to the first inner cover component.

In an embodiment of the disclosure, the cover component contacts the lifting component through a sealing material.

In an embodiment of the disclosure, the lifting component includes a front lifting component and a rear lifting component. The front lifting component is disposed in front of a center of the vehicle body. The rear lifting component is disposed behind the center of the vehicle body. The first inner cover component includes a front first inner cover component and a rear first inner cover component that are separately formed. The front first inner cover component contacts the front lifting component. The rear first inner cover component contacts the rear lifting component.

In an embodiment of the disclosure, the lifting component includes a right lifting component and a left lifting component. The right lifting component is disposed on a right side of the vehicle. The left lifting component is disposed on a left side of the vehicle. The first inner cover component includes a right first inner cover component and a left first inner cover component. The right first inner cover component contacts the right lifting component. The left first inner cover component contacts the left lifting component.

Based on the above, in the bottom structure of the vehicle of the disclosure, the cover component covers the lower portion of the battery fixing portion. The internal contact portion of the cover component contacts the lifting component from the inner side of the lifting component to prevent water from entering between the cover component and the lifting component. Accordingly, water splashing onto the battery fixing portion may be effectively avoided to prevent the battery fixing portion from being wetted by water and rusting. In addition, the internal contact portion of the cover component is located above the jack receiving portion to allow the jack receiving portion to be exposed under the cover component. Accordingly, the jack receiving portion may be utilized to operate a jack without unloading the cover component. Thus, the bottom structure of the vehicle of the disclosure can provide good waterproof effect and good operability of the lifting operation.

In order to make the features and advantages of the disclosure more comprehensible, the following examples are given and described in detail with the accompanying drawings as follows.

### BRIEF DESCRIPTION OF THE DRAWINGS

FIG. 1 is a bottom view of a vehicle according to an embodiment of the disclosure.

FIG. 2 is a bottom view of some components of the vehicle in FIG. 1.

FIG. 3 is a partially enlarged view of the vehicle in FIG. 1.

FIG. 4 is a cross-sectional view of the vehicle in FIG. 3 along line I-I.

FIG. 5 is a cross-sectional view of the vehicle in FIG. 3 along line II-II.

FIG. 6 is a perspective view of a portion structure of the cover component in FIG. 3.

FIG. 7 is a partially enlarged view of a vehicle according to another embodiment of the disclosure.

FIG. 8 is a cross-sectional view of the vehicle in FIG. 7 along line I-I.

FIG. 9 is a partially enlarged view of a vehicle according to another embodiment of the disclosure.

FIG. 10 is a cross-sectional view of the vehicle in FIG. 9 along line I-I.

FIG. 11 is a partially enlarged view of a vehicle according to another embodiment of the disclosure.

FIG. 12 is a cross-sectional view of the vehicle in FIG. 11 along line I-I.

FIG. 13 is a partially enlarged view of a vehicle according to another embodiment of the disclosure.

FIG. 14 is a cross-sectional view of the vehicle in FIG. 13 along line I-I.

FIG. 15 is a partially enlarged view of a vehicle according to another embodiment of the disclosure.

FIG. 16 is a cross-sectional view of the vehicle in FIG. 15 along line I-I.

FIG. 17 is a partially enlarged view of a vehicle according to another embodiment of the disclosure.

FIG. 18 is a cross-sectional view of the vehicle in FIG. 17 along line I-I.

### DESCRIPTION OF THE EMBODIMENTS

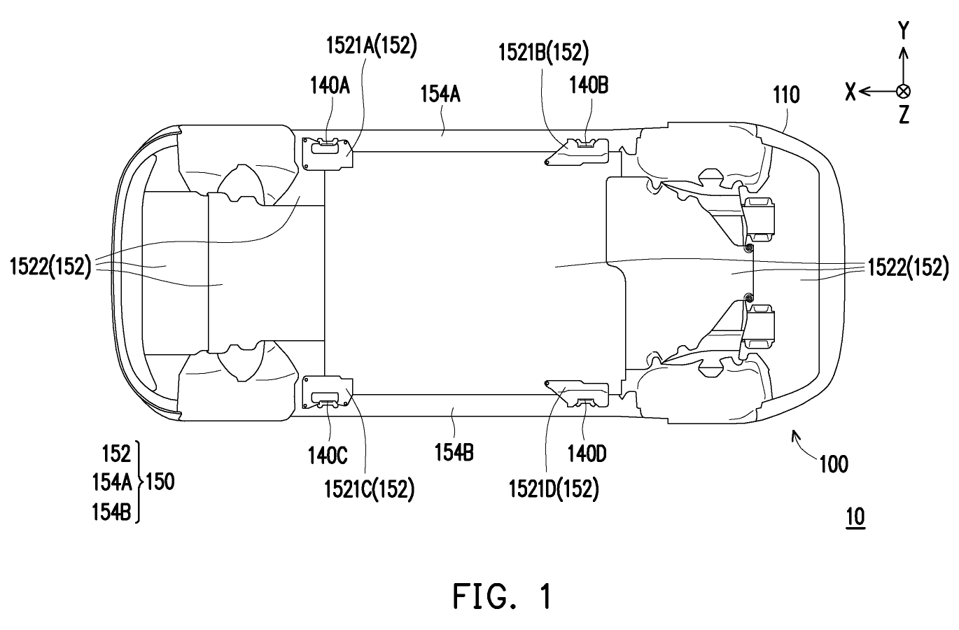

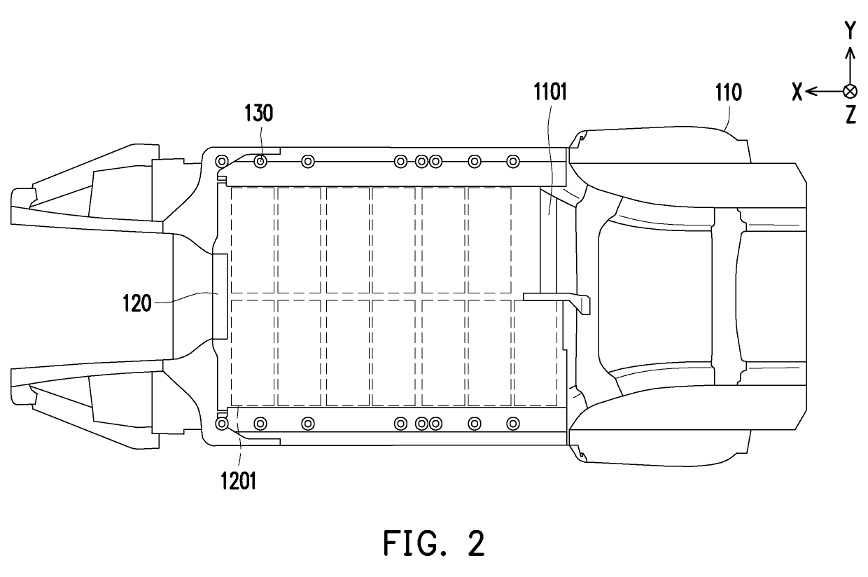

FIG. 1 is a bottom view of a vehicle according to an embodiment of the disclosure, which shows axial directions X, Y and Z. FIG. 2 is a bottom view of some components of the vehicle in FIG. 1. Referring to FIG. 1 and FIG. 2, a bottom structure 100 of a vehicle 10 of the embodiment includes a vehicle body 110, a battery 120, multiple battery fixing portions 130, multiple lifting components 140A, 140B, 140C and 140D, and a cover component 150. The vehicle body 110 has a base plate 1101. The battery 120 is disposed under the base plate 1101 in a top-bottom direction (the axial direction Z) of the vehicle 10 and includes multiple battery units 1201. The battery fixing portions 130 are, for example, bolts. The battery fixing portions 130 are disposed at a position closer to an outer side of the vehicle 10 compared to the battery 120, and fix the battery 120 to the vehicle body 110. The lifting components 140A, 140B, 140C and 140D are disposed at a position closer to the outer side of the vehicle 10 compared to the battery fixing portions 130.

In a front-rear direction (the axial direction X) of the vehicle 10, the lifting components 140A and 140C are disposed in front of a center of the vehicle body 110 and serve as front lifting components. The lifting components 140B and 140D are disposed behind the center of the vehicle body 110 and serve as rear lifting components. On the other hand, in a width direction (the axial direction Y) of the vehicle 10, the lifting components 140A and 140B are disposed on a left side of the vehicle 10 and serve as left lifting components. The lifting components 140C and 140D are disposed on a right side of the vehicle 10 and serve as right lifting components.

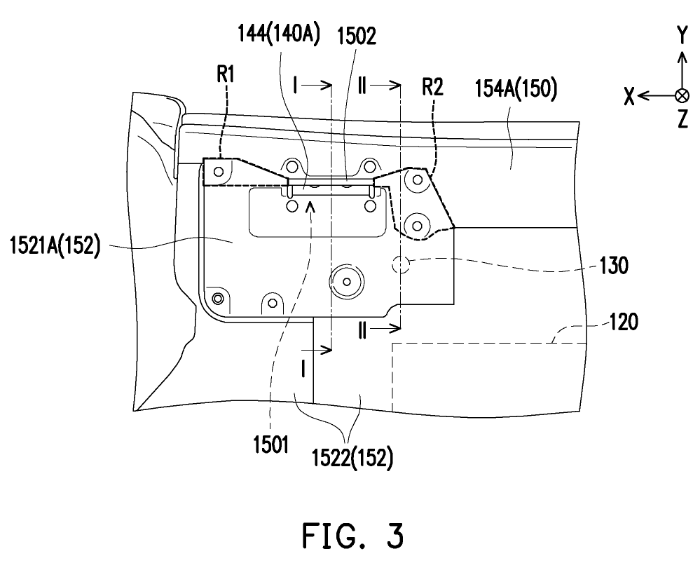

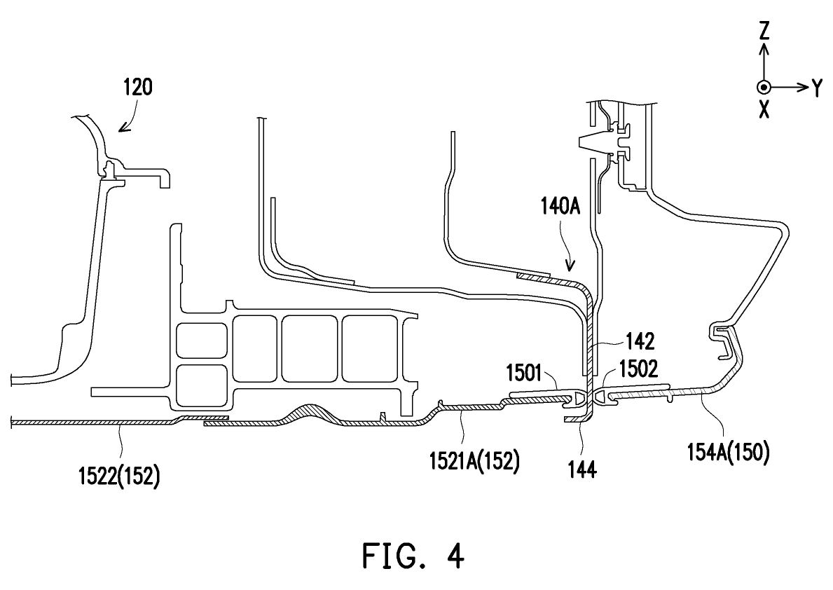

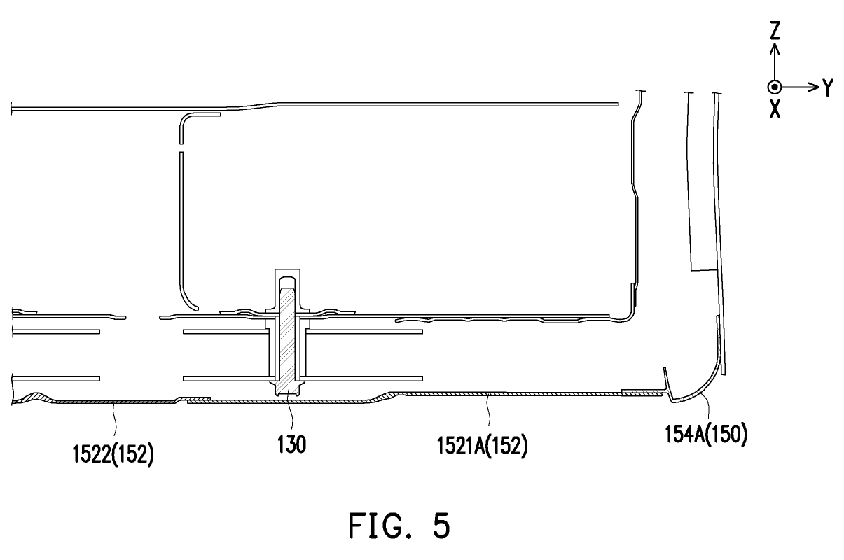

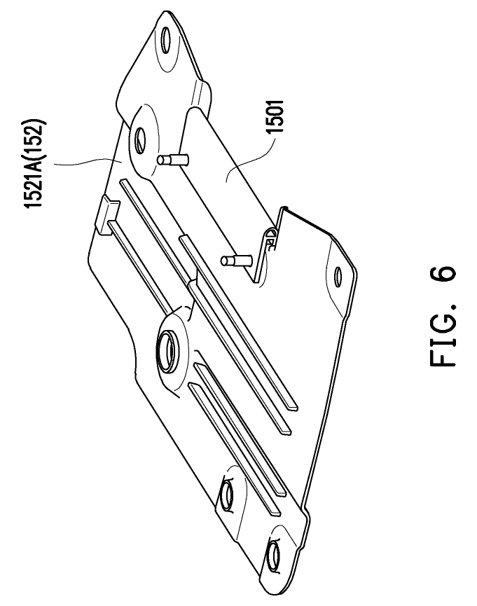

FIG. 3 is a partially enlarged view of the vehicle in FIG. 1. FIG. 4 is a cross-sectional view of the vehicle in FIG. 3 along line I-I. FIG. 5 is a cross-sectional view of the vehicle in FIG. 3 along line II-II. FIG. 6 is a perspective view of a portion structure of the cover component in FIG. 3. The cover component 150 is disposed under the battery 120 in the top-bottom direction (the axial direction Z) of the vehicle 10 as shown in FIG. 4 and covers a lower portion of the battery fixing portion 130 as shown in FIG. 5. The lifting component 140A has a longitudinal wall portion 142 as shown in FIG. 4 and has a jack receiving portion 144 at a lower end of the longitudinal wall portion 142. The longitudinal wall portion 142 extends along the top-bottom direction (the axial direction Z) of the vehicle 10. The jack receiving portion 144 extends from the lower end of the longitudinal wall portion 142 along the width direction (the axial direction Y) of the vehicle 10 toward an inner side of the vehicle 10. The configuration and operation manner of the lifting components 140B, 140C and 140D are the same or similar to the configuration and operation manner of the lifting component 140A, which will not be elaborated here. The cover component 150 has an internal contact portion 1501 as shown in FIG. 4 and FIG. 6. The internal contact portion 1501 is located above the jack receiving portion 144 in the top-bottom direction (the axial direction Z) of the vehicle 10, and contacts the lifting component 140A from an inner side of the lifting component 140A in the width direction (the axial direction Y) of the vehicle 10.

As described above, in the bottom structure 100 of the vehicle 10 of the embodiment, the cover component 150 covers the lower portion of the battery fixing portion 130. The internal contact portion 1501 of the cover component 150 contacts the lifting component 140A from the inner side of the lifting component 140A to prevent water from entering between the cover component 150 and the lifting component 140A. Accordingly, water splashing onto the battery fixing portion 130 may be effectively avoided to prevent the battery fixing portion 130 from being wetted by water and rusting. In addition, the internal contact portion 1501 of the cover component 150 is located above the jack receiving portion 144 to allow the jack receiving portion 144 to be exposed under the cover component 150. Accordingly, the jack receiving portion 144 may be utilized to operate a jack without unloading the cover component 150. Thus, the bottom structure 100 of the vehicle 10 of the embodiment can provide good waterproof effect and good operability for a lifting operation. Similarly, the cover component 150 may respectively have an internal contact portion at a position corresponding to the lifting components 140B, 140C and 140D, and is configured to respectively contact the lifting components 140B, 140C and 140D from an inner side in the width direction (the axial direction Y) of the vehicle 10. The configuration and operation manner are the same or similar to the configuration and operation manner of the internal contact portion 1501 at the lifting component 140A, which will not be elaborated here.

In addition, in the embodiment, the cover component 150 as shown in FIG. 4 further has an external contact portion 1502. The external contact portion 1502 contacts the lifting component 140A from an outer side of the lifting component 140A in the width direction (the axial direction Y) of the vehicle 10. Accordingly, the cover component 150, in addition to providing the waterproof effect on the inner side of the lifting component 140A through the internal contact portion 1501 as described above, further provides waterproof effect on the outer side of the lifting component 140A through the external contact portion 1502. Similarly, the cover component 150 may respectively have an external contact portion at a position corresponding to the lifting components 140B, 140C and 140D, and is configured to respectively contact the lifting components 140B, 140C and 140D from an outer side in the width direction (the axial direction Y) of the vehicle 10. The configuration and operation manner are the same or similar to the configuration and operation manner of the external contact portion 1502 at the lifting component 140A, which will not be elaborated here.

Furthermore, the internal contact portion 1501 and the external contact portion 1502 of the embodiment are, for example, sealing materials made of rubber or other suitable elastic materials. The internal contact portions and the external contact portions of the cover component 150 corresponding to the lifting components 140B, 140C and 140D are also, for example, sealing materials made of rubber or other suitable elastic materials. The cover component 150 tightly contacts the lifting components 140A, 140B, 140C and 140D through the sealing materials to reliably prevent water intrusion.

The cover component 150 of the embodiment will be described in detail below.

Referring to FIG. 1 and FIG. 3 to FIG. 5, the cover component 150 of the embodiment includes an inner cover component 152 and outer cover components 154A and 154B that are separately formed. The inner cover component 152 has the internal contact portion 1501 corresponding to the lifting component 140A and the internal contact portions corresponding to the lifting components 140B, 140C and 140D. The outer cover component 154A has the external contact portion 1502 corresponding to the lifting component 140A and the external contact portion corresponding to the lifting component 140B. The outer cover component 154B has the external contact portion 1502 corresponding to the lifting component 140C and the external contact portion corresponding to the lifting component 140D. Through dividing the cover component 150 into the inner cover component 152 and the outer cover components 154A and 154B that are separately formed as described above, the inner cover component 152 configured to contact the inner sides of the lifting components 140A, 140B, 140C and 140D and the outer cover components 154A and 154B configured to contact the outer sides of the lifting components 140A, 140B, 140C and 140D may each be easily assembled.

In detail, the inner cover component 152 of the cover component 150 of the embodiment includes a first inner cover components 1521A, 1521B, 1521C and 1521D and a second inner cover component 1522. In the front-rear direction (the axial direction X) of the vehicle 10, the first inner cover components 1521A and 1521C are located in front of the center of the vehicle body 110 and serve as front first inner cover components. The first inner cover components 1521B and 1521D are located behind the center of the vehicle body 110 and serve as rear first inner cover components. In the width direction (the axial direction Y) of the vehicle 10, the first inner cover components 1521A and 1521B are located on the left side of the vehicle 10 and serve as left first inner cover components. The first inner cover components 1521C and 1521D are located on the right side of the vehicle 10 and serve as right first inner cover components. The second inner cover component 1522 itself may be assembled by multiple components as shown in FIG. 1. Alternatively, at least a portion of the multiple components of the second inner cover component 1522 may be integrally connected, and the disclosure is not limited thereto.

The first inner cover component 1521A (the front first inner cover component/the left first inner cover component) of the inner cover component 152 has the internal contact portion 1501 corresponding to the lifting component 140A, and contacts the lifting component 140A (the front lifting component/the left lifting component) accordingly. The first inner cover component 1521B (the rear first inner cover component/the left first inner cover component) of the inner cover component 152 has the internal contact portion corresponding to the lifting component 140B, and contacts the lifting component 140B (the rear lifting component/the left lifting component) accordingly. The first inner cover component 1521C (the front first inner cover component/the right first inner cover component) of the inner cover component 152 has the internal contact portion corresponding to the lifting component 140C, and contacts the lifting component 140C (the front lifting component/the right lifting component) accordingly. The first inner cover component 1521D (the rear first inner cover component/the right first inner cover component) of the inner cover component 152 has the internal contact portion corresponding to the lifting component 140D, and contacts the lifting component 140D (the rear lifting component/the right lifting component) accordingly. The second inner cover component 1522 covers the lower portion of the battery 120 and is connected to the first inner cover components 1521A, 1521B, 1521C and 1521D. Through dividing the inner cover component 152 of the cover component 150 into the first inner cover components 1521A, 1521B, 1521C and 1521D and the second inner cover component 1522 that are separately formed as described above, each of the first inner cover components 1521A, 1521B, 1521C and 1521D with a smaller volume configured to contact the inner sides of the lifting components 140A, 140B, 140C and 140D may be individually assembled. The lifting components 140A, 140B, 140C and 140D may be easily avoided during the process of assembling the first inner cover components 1521A, 1521B, 1521C and 1521D to smoothly complete the assembly.

Furthermore, the first inner cover component 1521A of the inner cover component 152 and the outer cover component 154A overlap and are connected to each other at a front side of the internal contact portion 1501 in the front-rear direction (the axial direction X) of the vehicle 10 and at a rear side of the internal contact portion 1501 in the front-rear direction (the axial direction X) of the vehicle 10 as shown in FIG. 3. A portion where the inner cover component 152 and the outer cover component 154A overlap with each other is indicated as overlapping regions R1 and R2 in FIG. 3. Accordingly, water may be prevented from entering at the front side and the rear side of the internal contact portion 1501. The first inner cover component 1521B of the inner cover component 152 and the outer cover component 154A also overlap and are connected to each other in the same or similar manner as the foregoing. The first inner cover component 1521C of the inner cover component 152 and the outer cover component 154B also overlap and are connected to each other in the same or similar manner as the foregoing. The first inner cover component 1521D of the inner cover component 152 and the outer cover component 154B also overlap and are connected to each other in the same or similar manner as the foregoing, which will not be elaborated here.

The following describes other forms of the cover component of the disclosure with specific embodiments.

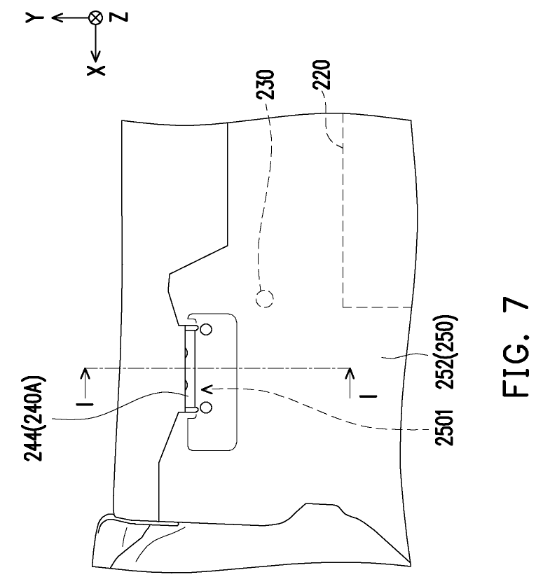

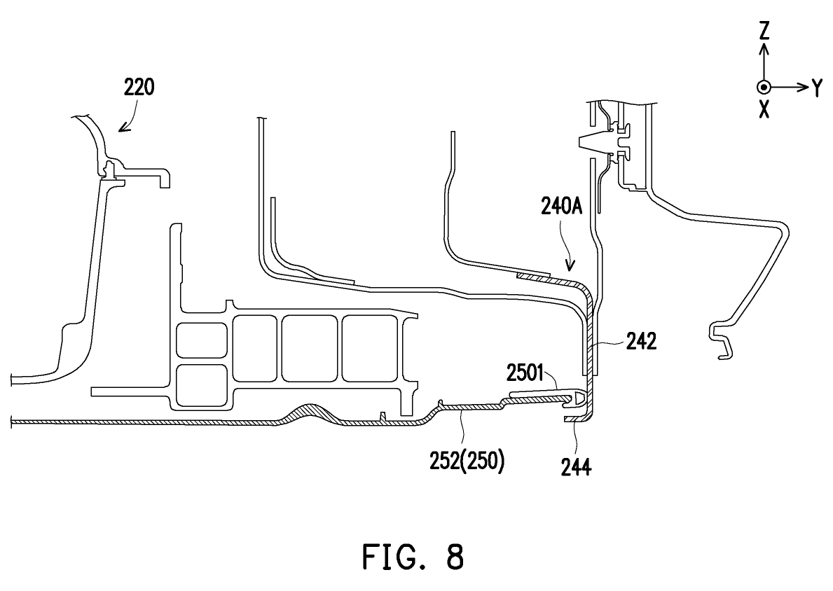

FIG. 7 is a partially enlarged view of a vehicle according to another embodiment of the disclosure. FIG. 8 is a cross-sectional view of the vehicle in FIG. 7 along line I-I. The configuration and operation manner of a battery 220, a battery fixing portion 230, an internal contact portion 2501, a lifting component 240A, a longitudinal wall portion 242, and a jack receiving portion 244 in the embodiment shown in FIG. 7 and FIG. 8 are the same or similar to the configuration and operation manner of the battery 120, the battery fixing portion 130, the internal contact portion 1501, the lifting component 140A, the longitudinal wall portion 142, and the jack receiving portion 144 in the embodiment shown in FIG. 3 and FIG. 4, which will not be elaborated here. The main difference between the embodiment shown in FIG. 7 and FIG. 8 and the embodiment shown in FIG. 3 and FIG. 4 is that a cover component 250 in FIG. 7 and FIG. 8 does not include the outer cover component 154A and the external contact portion 1502 in FIG. 3 and FIG. 4. An inner cover component 252 in FIG. 7 and FIG. 8 is an integral structure rather than the inner cover component 152 in FIG. 3 and FIG. 4 being divided into the first inner cover component 1521A and the second inner cover component 1522.

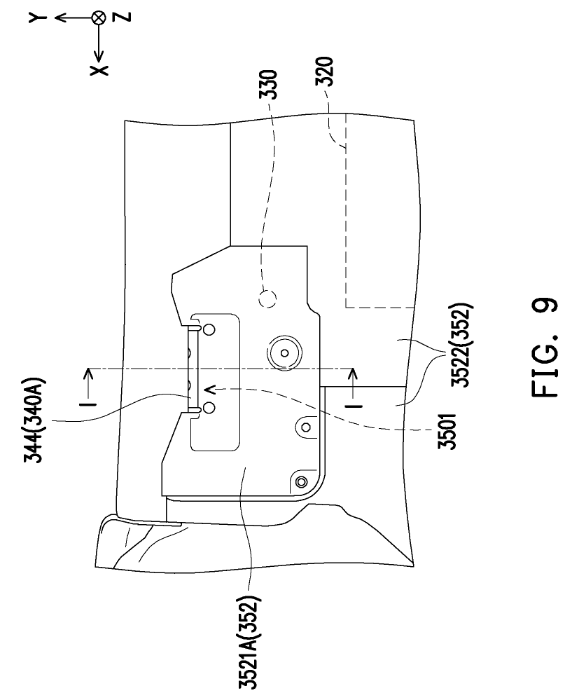

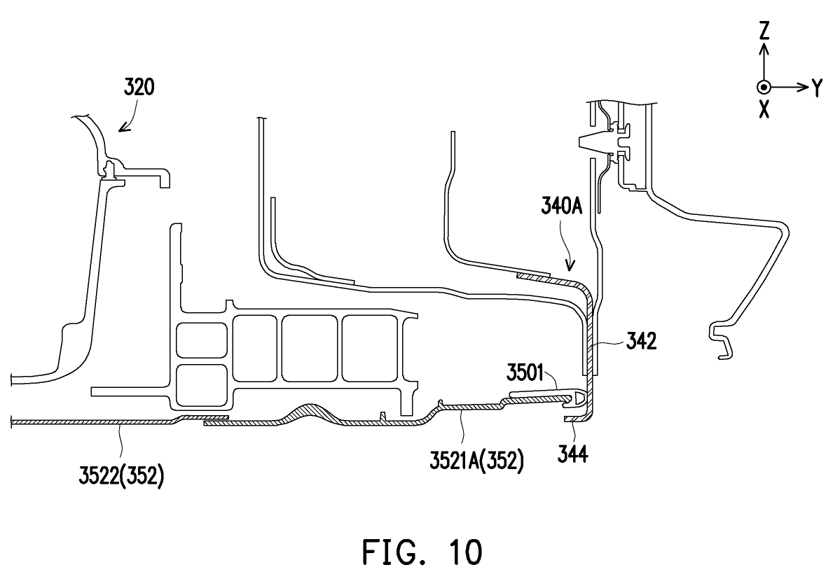

FIG. 9 is a partially enlarged view of a vehicle according to another embodiment of the disclosure. FIG. 10 is a cross-sectional view of the vehicle in FIG. 9 along line I-I. The configuration and operation manner of a battery 320, a battery fixing portion 330, an inner cover component 352, a first inner cover component 3521A, a second inner cover component 3522, an internal contact portion 3501, a lifting component 340A, a longitudinal wall portion 342, and a jack receiving portion 344 in the embodiment shown in FIG. 9 and FIG. 10 are the same or similar to the configuration and operation manner of the battery 120, the battery fixing portion 130, the inner cover component 152, the first inner cover component 1521A, the second inner cover component 1522, the internal contact portion 1501, the lifting component 140A, the longitudinal wall portion 142, and the jack receiving portion 144 in the embodiment shown in FIG. 3 and FIG. 4, which will not be elaborated here. The main difference between the embodiment shown in FIG. 9 and FIG. 10 and the embodiment shown in FIG. 3 and FIG. 4 is that a cover component 250 in FIG. 9 and FIG. 10 does not include the outer cover component 154A and the external contact portion 1502 in FIG. 3 and FIG. 4.

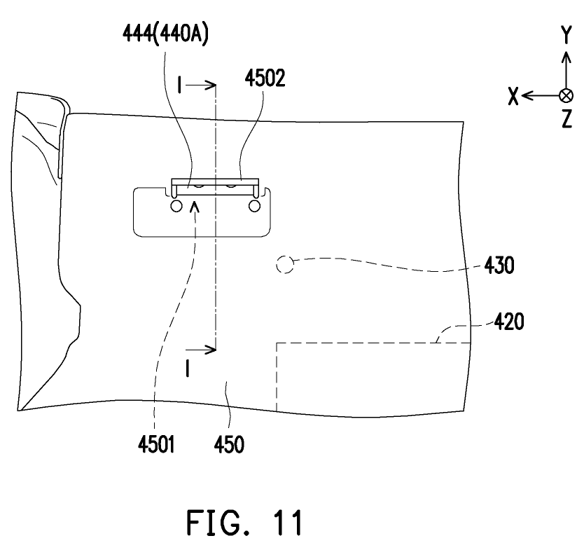

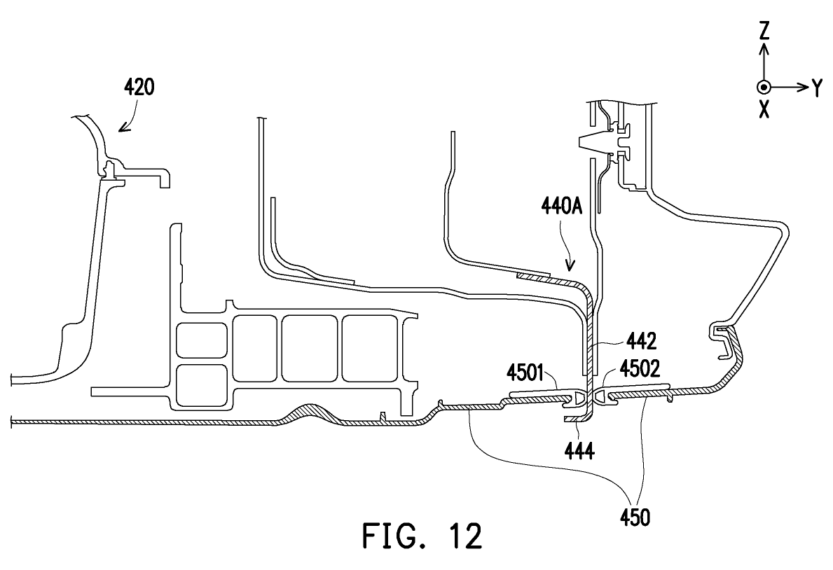

FIG. 11 is a partially enlarged view of a vehicle according to another embodiment of the disclosure. FIG. 12 is a cross-sectional view of the vehicle in FIG. 11 along line I-I. The configuration and operation manner of a battery 420, a battery fixing portion 430, an internal contact portion 4501, an external contact portion 4502, a lifting component 440A, a longitudinal wall portion 442, and a jack receiving portion 444 in the embodiment shown in FIG. 11 and FIG. 12 are the same or similar to the configuration and operation manner of the battery 120, the battery fixing portion 130, the internal contact portion 1501, the external contact portion 1502, the lifting component 140A, the longitudinal wall portion 142, and the jack receiving portion 144 in the embodiment shown in FIG. 3 and FIG. 4, which will not be elaborated here. The main difference between the embodiment shown in FIG. 11 and FIG. 12 and the embodiment shown in FIG. 3 and FIG. 4 is that a cover component 450 in FIG. 11 and FIG. 12 is an integral structure rather than the cover component 150 in FIG. 3 and FIG. 4 being divided into the first inner cover component 1521A, the second inner cover component 1522, and the outer cover component 154A.

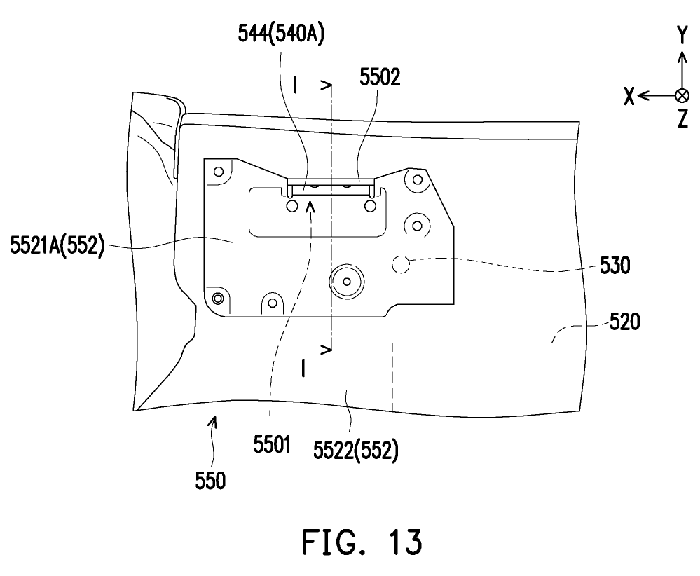

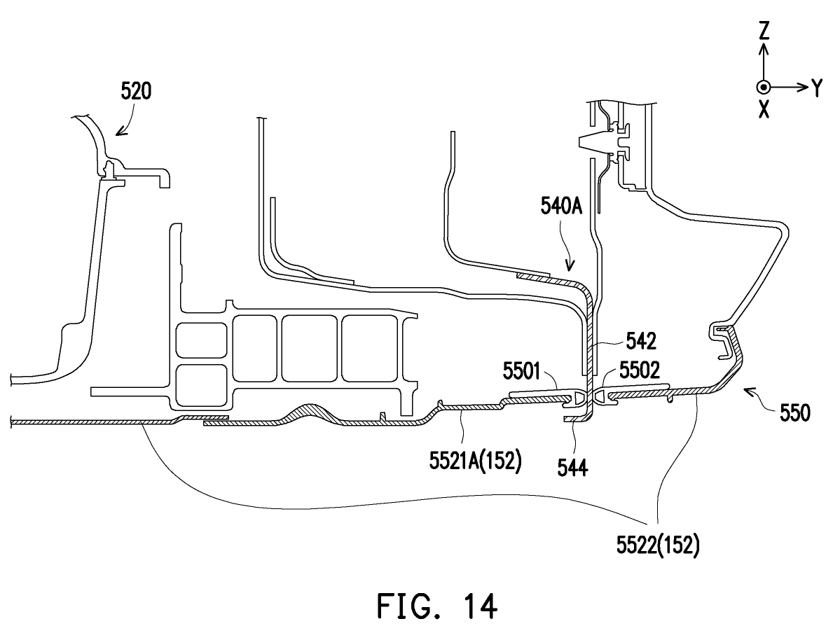

FIG. 13 is a partially enlarged view of a vehicle according to another embodiment of the disclosure. FIG. 14 is a cross-sectional view of the vehicle in FIG. 13 along line I-I. The configuration and operation manner of a battery 520, a battery fixing portion 530, a first inner cover component 5521A, an internal contact portion 5501, an external contact portion 5502, a lifting component 540A, a longitudinal wall portion 542, and a jack receiving portion 544 in the embodiment shown in FIG. 13 and FIG. 14 are the same or similar to the configuration and operation manner of the battery 120, the battery fixing portion 130, the first inner cover component 1521A, the internal contact portion 1501, the external contact portion 1502, the lifting component 140A, the longitudinal wall portion 142, and the jack receiving portion 144 in the embodiment shown in FIG. 3 and FIG. 4, which will not be elaborated here. The main difference between the embodiment shown in FIG. 13 and FIG. 14 and the embodiment shown in FIG. 3 and FIG. 4 is that a second inner cover component 5522 of an inner cover component 552 of a cover component 550 in FIG. 13 and FIG. 14 integrally extends to an outer side of the first inner cover component 5521A to replace the outer cover component 154A in FIG. 3 and FIG. 4. The external contact portion 5502 is formed on the second inner cover component 5522 that extends to the outer side of the first inner cover component 5521A.

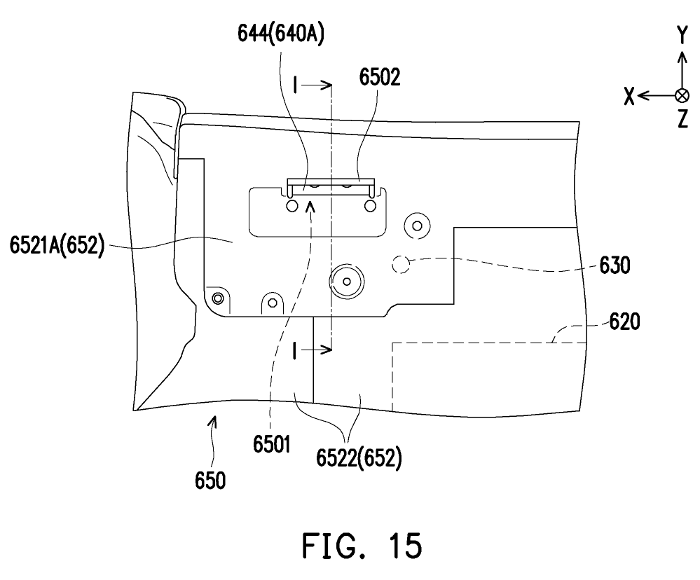

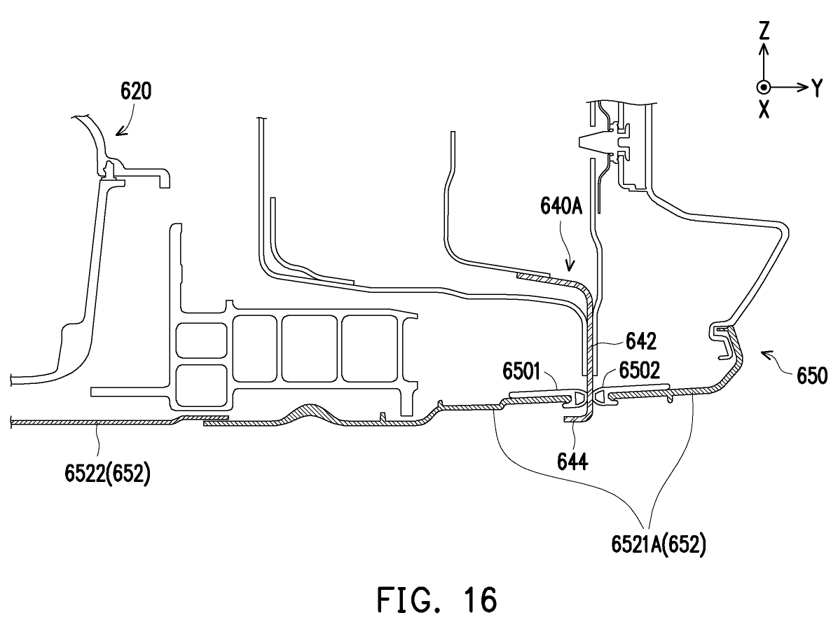

FIG. 15 is a partially enlarged view of a vehicle according to another embodiment of the disclosure. FIG. 16 is a cross-sectional view of the vehicle in FIG. 15 along line I-I. The configuration and operation manner of a battery 620, a battery fixing portion 630, a second inner cover component 6522, an internal contact portion 6501, an external contact portion 6502, a lifting component 640A, a longitudinal wall portion 642, and a jack receiving portion 644 in the embodiment shown in FIG. 15 and FIG. 16 are the same or similar to the configuration and operation manner of the battery 120, the battery fixing portion 130, the second inner cover component 1522, the internal contact portion 1501, the external contact portion 1502, the lifting component 140A, the longitudinal wall portion 142, and the jack receiving portion 144 in the embodiment shown in FIG. 3 and FIG. 4, which will not be elaborated here. The main difference between the embodiment shown in FIG. 15 and FIG. 16 and the embodiment shown in FIG. 3 and FIG. 4 is that a first inner cover component 6521A of an inner cover component 652 of a cover component 650 in FIG. 15 and FIG. 16 integrally extends outward to replace the outer cover component 154A in FIG. 3 and FIG. 4. The external contact portion 6502 is formed on the first inner cover component 6521A that extends outward.

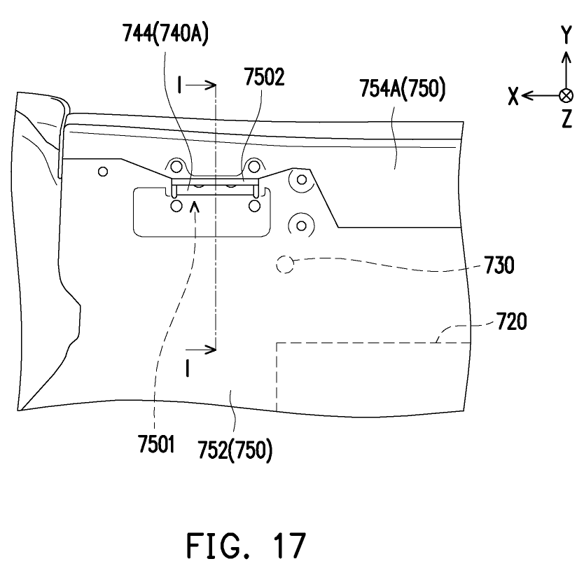

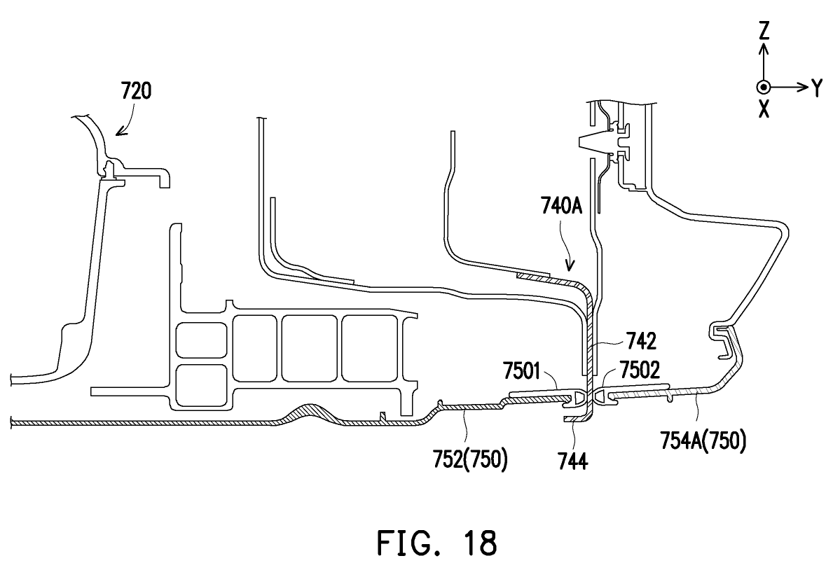

FIG. 17 is a partially enlarged view of a vehicle according to another embodiment of the disclosure. FIG. 18 is a cross-sectional view of the vehicle in FIG. 17 along line I-I. The configuration and operation manner of a battery 720, a battery fixing portion 730, an outer cover component 754A, an internal contact portion 7501, an external contact portion 7502, a lifting component 740A, a longitudinal wall portion 742, and a jack receiving portion 744 in the embodiment shown in FIG. 17 and FIG. 18 are the same or similar to the configuration and operation manner of the battery 120, the battery fixing portion 130, the outer cover component 154A, the internal contact portion 1501, the external contact portion 1502, the lifting component 140A, the longitudinal wall portion 142, and the jack receiving portion 144 in the embodiment shown in FIG. 3 and FIG. 4, which will not be elaborated here. The main difference between the embodiment shown in FIG. 17 and FIG. 18 and the embodiment shown in FIG. 3 and FIG. 4 is that an inner cover component 752 in FIG. 17 and FIG. 18 is an integral structure rather than the inner cover component 152 in FIG. 3 and FIG. 4 being divided into the first inner cover component 1521A and the second inner cover component 1522.

In summary, in the bottom structure of the vehicle of the disclosure, the cover component covers the lower portion of the battery fixing portion. The internal contact portion of the cover component contacts the lifting component from the inner side of the lifting component to prevent water from entering between the cover component and the lifting component. Accordingly, water splashing onto the battery fixing portion may be effectively avoided to prevent the battery fixing portion from being wetted by water and rusting. In addition, the internal contact portion of the cover component is located above the jack receiving portion to allow the jack receiving portion to be exposed under the cover component. Accordingly, the jack receiving portion may be utilized to operate a jack without unloading the cover component. Thus, the bottom structure of the vehicle of the disclosure can provide good waterproof effect and good operability of the lifting operation.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A bottom structure of a vehicle, comprising:
a vehicle body, having a base plate;
a battery, disposed under the base plate;
a battery fixing portion, disposed at a position closer to an outer side of the vehicle compared to the battery, and fixing the battery to the vehicle body;
a lifting component, disposed at a position closer to the outer side of the vehicle compared to the battery fixing portion, wherein a lower end of the lifting component has a jack receiving portion; and
a cover component, disposed under the battery and covering a lower portion of the battery fixing portion, wherein
the cover component has an internal contact portion, and the internal contact portion is located above the jack receiving portion, and contacts the lifting component from an inner side of the lifting component in a width direction of the vehicle.

2. The bottom structure of the vehicle according to claim 1, wherein,
the cover component has an external contact portion, and the external contact portion contacts the lifting component from an outer side of the lifting component in the width direction of the vehicle.

3. The bottom structure of the vehicle according to claim 2, wherein,
the cover component comprises an inner cover component and an outer cover component that are separately formed,
the inner cover component has the internal contact portion, and
the outer cover component has the external contact portion.

4. The bottom structure of the vehicle according to claim 3, wherein,
the inner cover component and the outer cover component overlap and are connected to each other at a front side of the internal contact portion and a rear side of the internal contact portion.

5. The bottom structure of the vehicle according to claim 3, wherein,
the lifting component has a longitudinal wall portion extending along a top-bottom direction of the vehicle,
the jack receiving portion extends from a lower end of the longitudinal wall portion along the width direction of the vehicle toward an inner side of the vehicle, and
the inner cover component comprises a first inner cover component and a second inner cover component that are separately formed, wherein
the first inner cover component has the internal contact portion, and
the second inner cover component covers a lower portion of the battery and is connected to the first inner cover component.

6. The bottom structure of the vehicle according to claim 5, wherein,
the first inner cover component and the outer cover component overlap and are connected to each other at a front side of the internal contact portion and a rear side of the internal contact portion.

7. The bottom structure of the vehicle according to claim 1, wherein,
the lifting component has a longitudinal wall portion extending along a top-bottom direction of the vehicle,
the jack receiving portion extends from a lower end of the longitudinal wall portion along the width direction of the vehicle toward an inner side of the vehicle, and
the cover component comprises a first inner cover component and a second inner cover component that are separately formed,
the first inner cover component has the internal contact portion, and
the second inner cover component covers a lower portion of the battery and is connected to the first inner cover component.

8. The bottom structure of the vehicle according to claim 1, wherein,
the cover component contacts the lifting component through a sealing material.

9. The bottom structure of the vehicle according to claim 5, wherein,
the lifting component comprises a front lifting component and a rear lifting component,
the front lifting component is disposed in front of a center of the vehicle body,
the rear lifting component is disposed behind the center of the vehicle body,
the first inner cover component comprises a front first inner cover component and a rear first inner cover component that are separately formed,
the front first inner cover component contacts the front lifting component, and
the rear first inner cover component contacts the rear lifting component.

10. The bottom structure of the vehicle according to claim 5, wherein,
the lifting component comprises a right lifting component and a left lifting component,
the right lifting component is disposed on a right side of the vehicle,
the left lifting component is disposed on a left side of the vehicle,
the first inner cover component comprises a right first inner cover component and a left first inner cover component,
the right first inner cover component contacts the right lifting component, and
the left first inner cover component contacts the left lifting component.

11. The bottom structure of the vehicle according to claim 2, wherein,
the cover component contacts the lifting component through a sealing material.

12. The bottom structure of the vehicle according to claim 3, wherein,
the cover component contacts the lifting component through a sealing material.

13. The bottom structure of the vehicle according to claim 4, wherein,
the cover component contacts the lifting component through a sealing material.

14. The bottom structure of the vehicle according to claim 5, wherein,
the cover component contacts the lifting component through a sealing material.

15. The bottom structure of the vehicle according to claim 6, wherein,
the cover component contacts the lifting component through a sealing material.

16. The bottom structure of the vehicle according to claim 7, wherein,
the cover component contacts the lifting component through a sealing material.

17. The bottom structure of the vehicle according to claim 7, wherein,
the lifting component comprises a front lifting component and a rear lifting component,
the front lifting component is disposed in front of a center of the vehicle body,
the rear lifting component is disposed behind the center of the vehicle body,
the first inner cover component comprises a front first inner cover component and a rear first inner cover component that are separately formed,
the front first inner cover component contacts the front lifting component, and
the rear first inner cover component contacts the rear lifting component.

18. The bottom structure of the vehicle according to claim 7, wherein,
the lifting component comprises a right lifting component and a left lifting component,
the right lifting component is disposed on a right side of the vehicle,
the left lifting component is disposed on a left side of the vehicle,
the first inner cover component comprises a right first inner cover component and a left first inner cover component,
the right first inner cover component contacts the right lifting component, and
the left first inner cover component contacts the left lifting component.
